(19) United States
(12) Patent Application Publication
(10) Pub. No.: US 2022/0118877 A1
(43) Pub. Date: Apr. 21, 2022

(54) SYSTEM FOR RECHARGING WITH ENERGY ELECTRICAL APPARATUSES, IN PARTICULAR FRONT-WHEEL DRIVE ELECTRIC VEHICLES, AND CONNECTING CABLE USABLE IN SUCH A SYSTEM

(71) Applicant: ANGE TECHNOLOGIES, Paris (FR)

(72) Inventor: Jérémy MARTINEZ, Paris (FR)

(21) Appl. No.: 17/426,306

(22) PCT Filed: Jan. 31, 2020
(86) PCT No.: PCT/FR2020/050154

§ 371 Date: Jul. 28, 2021

(30) Foreign Application Priority Data
Jan. 31, 2019 (FR) 1900945

(51) Int. Cl. B60L 53/66; B60L 53/16; H02J 13/00; H02J 7/00; B60L 53/18

(52) U.S. Cl. CPC B60L 53/665; B60L 53/16; B60L 2240/72; H02J 7/00032; B60L 53/18; H02J 13/00026

(57) ABSTRACT

This system for recharging with electrical energy includes at least one connection terminal associated with a structure that is equipped with: —at least one terminal connector for a connecting cable formed, inter alia, from conductive wires intended to be connected to the vehicles with a view to performing a charge thereof using an energy source, and—a managing assembly for managing the operation of the system. Provision is made for an identification code (CID) associated with the connecting cable and for transmitting means for transmitting this code to the managing assembly with a view to permitting in particular the charge of the vehicle associated with the connecting cable. This system can be applied to recharge electric vehicles.

The present invention relates to a system for recharging electrical apparatuses, in particular vehicles having electrical traction, with electrical energy, the system comprising at least one connection terminal provided with:
at least one terminal connector for a connection cable formed inter alia by conductive wires that are intended to be connected to said vehicles with a view to charging them from an energy source,
a management assembly for managing the operation of said system.

Vehicles moved by electric motors are becoming increasingly widespread. These vehicles require batteries which it is expedient to recharge. To this end, provision has been made to install recharging systems, which are intended to be present in large numbers. The problem of management then arises when these systems are accessible to many vehicles, and of allocating the costs to each user using them.

Such a system is disclosed in the United States patent No. U.S. Pat. No. 8,890,475. This system is formed by a terminal which establishes the connection between the current source and the vehicle battery which is to be charged. This terminal comprises a telescopic arm which comes in contact with another arm attached to the vehicle in question. The exchanges of information take place via wires coupled to said arm.

One major drawback of this known system is that it involves installation that is rather complicated, due inter alia to its two arms, and therefore expensive.

The object of the invention is to provide a system that does not require such installation and which provides a great simplification on the user side.

To this end, a recharging system as described in the preamble is remarkable in that an identification code is associated with said connection cable and in that transmission means are provided for transmitting this code to said management assembly with a view to authorizing, in particular, charging of the vehicle attached to said connection cable.

The invention also relates to a connection cable usable for such a system. It should be noted that the cable embodiments according to the invention offer advantages for use, in particular they are not large and they can be positioned easily on the ground without impeding inter alia the movement of pedestrians.

The following description accompanied by the appended drawings, all given by way of nonlimiting example, will clearly show how the invention may be embodied, in the drawings:

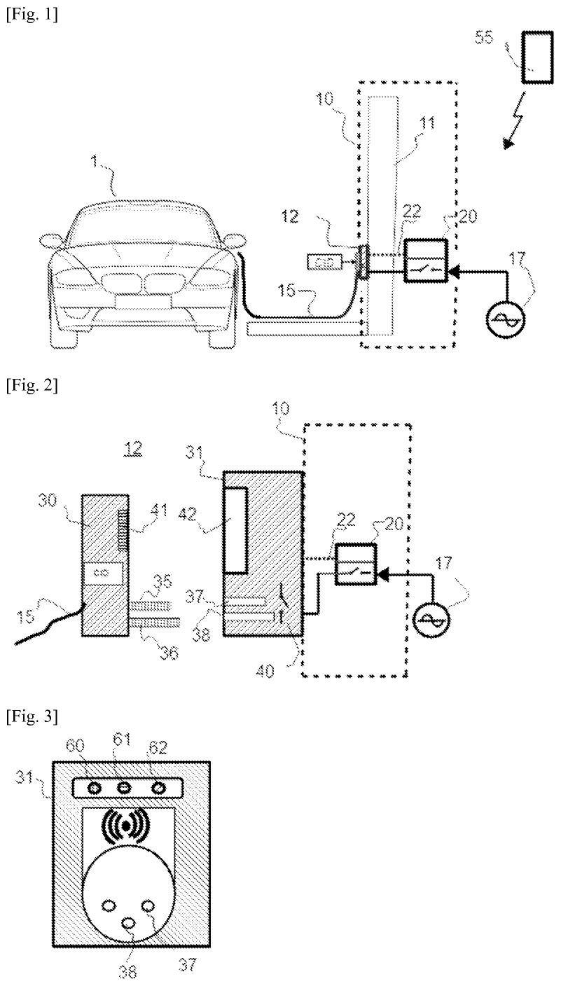

FIG. 1 shows a recharging system according to the invention,

FIG. 2 represents a terminal connector according to the invention,

FIG. 3 represents a front view of a connection part of a terminal connector,

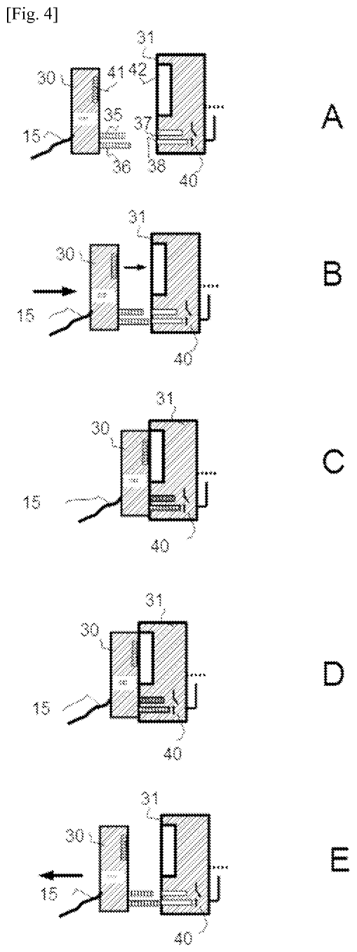

FIG. 4 illustrates the operation of the system of the invention when connecting up a connection cable,

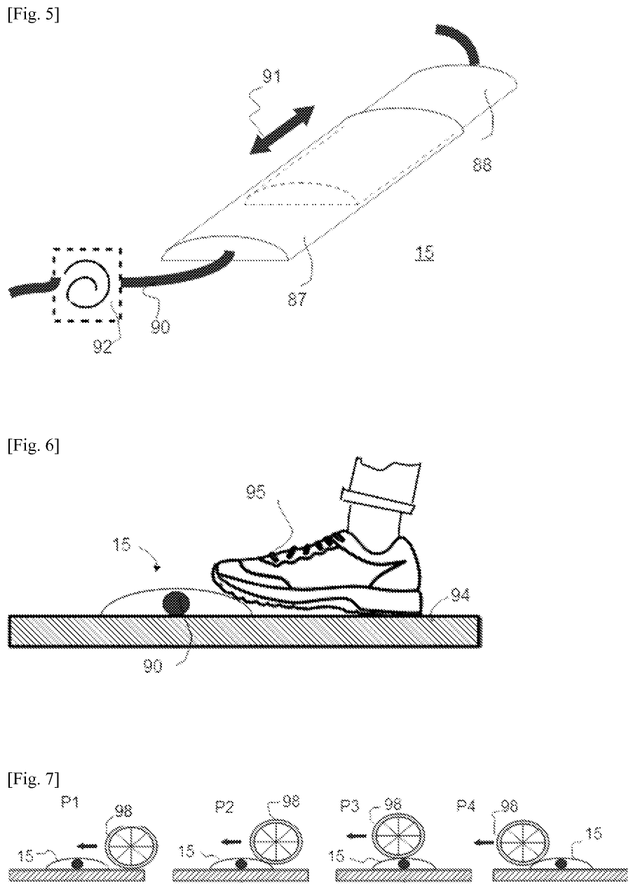

FIG. 5 shows a first embodiment of a connection cable,

FIG. 6 explains a first advantage relating to pedestrians, which is obtained by this first embodiment of the connection cable,

FIG. 7 explains another advantage obtained by this first embodiment, relating to rolling objects running over said connection cable,

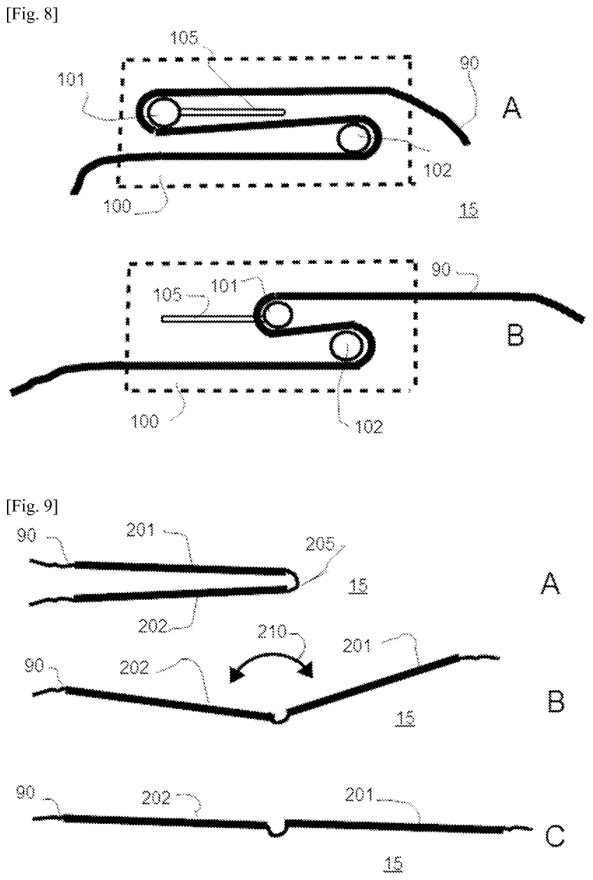

FIG. 8 shows a second embodiment of a connection cable,

FIG. 9 shows a third embodiment.

In FIG. 1, the reference 1 indicates a vehicle moved by an electric motor supplied by batteries (not shown). These batteries are charged from an energy source 17. This energy source may consist of the electrical grid. A connection terminal 10 provides the interface between the vehicle 1 and the energy source 17. This connection terminal 10 is supported by a framework 11 on which a terminal connector 12 is fixed, the latter making it possible inter alia to connect up a connection cable 15 comprising conductive wires with a view to transmitting the energy to the vehicle 1. A management assembly 20 manages the operation of the system.

The problem with this type of system is managing the charging of the vehicles, in particular, and verifying that the owner of the vehicle or a recipient is actually authorized to carry out this charging, so that the costs resulting therefrom are allocated correctly and the system operator is paid.

In order to solve this problem, the system of the invention proposes that an identification code (CID) be associated with said connection cable 15 and that transmission means 22 be provided for transmitting this code (for example via the Internet) to said management assembly 20 with a view to authorizing charging of the vehicle attached to said cable and billing the person responsible for the vehicle. This billing is carried out for a limited duration, according to one embodiment, so that a third party can have access to the terminal connector 12 by disconnecting, after the charging, the cable of a first client who is already connected. Furthermore, separation of the cable of the first client during the charging is detected by the switch circuit 40, then the charging is interrupted and the billing of the first client is stopped. A certain degree of protection is thus obtained against premature or criminal connecting.

FIG. 2 shows a terminal connector structure 12. It is composed of a first connection part 30 connected to the connection cable 15 and a second connection part 31 connected to the connection terminal 10. The connector 12 makes it possible to transfer electrical energy by means of pins 35 and 36 of the part 30, which cooperate with sockets 37 and 38 of the part 31. It will be noted that the pins 35 and 36 have different lengths and that the sockets 37 and 38 have depths corresponding to the length of the pins 35 and 36. A switch circuit 40 makes it possible to detect correct connection of the cable 15 to the connection terminal 10. The connection part 30 connected to the cable 15 has been provided with a circuit for an identification code CID. According to one embodiment, this code is transmitted by using the radio identification protocol, known by the abbreviation RFID (radiofrequency identification), which is established between RFID circuits 41 and 42 respectively incorporated into the parts 30 and 31. The identification code CID transmitted in this way is transferred by the transmission means 22 to the management assembly 20.

FIG. 3 shows a front view of the connection part 31. A set of three indicator lamps of the LED type in three different colors is arranged on this face; for example, a green lamp 60 indicates that the terminal 10 is available, a red lamp 61 indicates that the terminal 10 is being used, and the blue lamp 62 may signal malfunction of said terminal 10. The distribution of the sockets 37 and 38 is specific in order to avoid the use of cables not suitable for the system of the invention and other illegitimate activity.

The operation of the system of the invention is illustrated by FIG. 4, which explains the various operating phases at A, B, C, D and E.

Phase A relates to the step of connection. The circuit 40 is in standby, that is to say no pin is inserted, and therefore no delivery of current for the vehicle is possible.

Phase B is the step of connection. The pins 35 and 36 are respectively inserted into the sockets 37 and 38, which activates the switch circuit 40 thus detecting the connection. The validation protocol may then be started, the identification code is then in the validation phase.

Phase C is the phase according to which the joining of the outlet 31 to the management assembly 20 is carried out. The request to charge the battery of the vehicle may be transmitted if the management assembly gives authorization therefor.

Phase D is the verification phase carried out by the management assembly 20 in order to obtain or not obtain the authorization to carry out charging of the vehicle for a predefined maximum time.

Phase E relates to the step of disconnection so as to return to phase A.

FIG. 5 shows a first embodiment of the connection cable 15.

This cable is composed of two casings 87 and 88 in which the conductive wires bearing the reference 90 are accommodated. These casings 87 and 88 are engaged in one another as indicated by the arrow 91. The length of these casings is such that, in the folded position, they make it possible to accommodate the cable 15 easily in the trunk of a vehicle. In the deployed position, it is then possible to be able to connect to a terminal 10 at a greater or lesser distance away.

According to one embodiment, a wire winder 92 is provided at one end of the cable. This winder may be of a well-known type which is found particularly in vacuum cleaners.

The profile of these casings, in the shape of an arc of a circle, is such that they do not create an abrupt transition at the level of the ground 94 on which they are placed, as is shown by FIG. 6. They do not constitute an obstacle for a pedestrian. There is no need to step over these casings, and they may place their shoes 95 on top without hindrance and without tripping.

This profile makes it easy for rolling objects accompanying the pedestrians, such as a trolley and strollers, for example, to pass over. This is illustrated in FIG. 7. This figure shows the successive positions P1, P2, P3, P4 of a wheel 98 when passing over the cable 15.

FIG. 8 shows another embodiment of the cable 15. According to this embodiment, the cable is inserted into a sliding device 100. The conductive wires 90 are wound over two pulleys 101 and 102, one of which, pulley 101, can be moved along a rail 105 from a position shown at A in FIG. 8 and, under the effect of a pull exerted by the user, this pulley assumes a position shown at B on the same rail and, under the effect of a spring (not shown), returns to its initial position when said pull is no longer exerted.

FIG. 9 shows a third embodiment of the connection cable 15. It is composed essentially of two straight rigid guides 201 and 202 connected at one of their ends by a flexible part 205. These guides support the wires 90. At A, these two parts 201 and 202 have been represented in the folded position, that is to say they are in contact with one another. At B, the deployment of these parts is shown, as suggested by the double arrow 210. At C, the cable is represented in the fully deployed position. The length of said guides is compatible with storage in a trunk of an automobile 1.

The invention is of course in no way limited to the example described, which is given purely by way of indication, and numerous modifications may readily be made by the person skilled in the art without thereby departing from the scope of the invention.

In particular, instead of using the RFID protocol, it is possible to use QR codes, these being placed on the connection part 30 and the reader being placed on the connection part 31 of the terminal 10.

It is also possible to provide a satellite management device 55 consisting of a program implemented in a telephone of the so-called smartphone type, which allows the user to find a free connection terminal 10 in proximity to their vehicle 1. Other information may be made accessible, such as its consumption and the costs that it incurs. This device communicates with the management assembly 20 via the Internet.

1. A system for recharging electrical apparatuses, comprising vehicles having electrical traction, with electrical energy, the system comprising at least one connection terminal provided with:
at least one terminal connector for a connection cable formed inter alia by conductive wires that are intended to be connected to said vehicles with a view to charging them from an energy source,
a management assembly for managing the operation of said system,
wherein an identification code (CID) is associated with said connection cable and in that transmission means are provided for transmitting this identification code to said management assembly to authorize charging of the vehicle attached to said connection cable.

2. The system as claimed in claim 1, wherein the management assembly is in charge of the billing relating to a client connected to said connection terminal.

3. The system as claimed in claim 1, wherein transmission means comprise an RFID circuit.

4. The system as claimed in claim 1, wherein the transmission means comprise a QR code reader.

5. The system as claimed in claim 1 having a plurality of connection terminals, wherein at least one satellite management device is provided, which is assigned to the users of the system in order to locate a connection terminal available with a view to charging their vehicle.

6. The system as claimed in claim 5, wherein the satellite device is provided with transmission means using the Internet.

7. The system as claimed in claim 5, wherein the satellite device consists of a smartphone with which an application for accessing said management system is associated.

8. The system as claimed in claim 1, wherein the management assembly authorizes the charging of an apparatus for a limited duration.

9. The system as claimed in claim 1, wherein the management assembly stops the billing for a client who is prematurely disconnected.

10. The system as claimed in claim 1, wherein said cable is designed to be transported in the vehicles.

11. A connection cable usable for a system as claimed in claim 1, wherein said cable is formed by rigid guides that can be folded lengthwise so as to have dimensions compatible with being arranged inside a vehicle.

12. A connection cable usable for a system as claimed in claim 1, wherein said cable is formed by a telescopic casing enclosing said conductive wires, which in the folded position occupies a space compatible with being arranged inside the vehicle and which in the unfolded position allows connection to said connection terminal as far away as possible.

13. A connection cable usable for a system as claimed in claim 1, wherein said conductive wires are wound up inside a sliding device formed by a fixed part and a mobile part sliding along a rail.

14. A connection cable usable for a system as claimed in claim 1, wherein a wire winder is provided at one end of the cable.
